(19) United States
(12) Patent Application Publication
(10) Pub. No.: US 2010/0231961 A1
(43) Pub. Date: Sep. 16, 2010

(54) IMAGE PROCESSING APPARATUS, SYSTEM, AND IMAGE PROCESSING METHOD

(75) Inventor: Kenta Fukushima, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/708,819

(22) Filed: Feb. 19, 2010

(30) Foreign Application Priority Data
Mar. 11, 2009 (JP) 2009-058697

(51) Int. Cl. G06F 3/12

(52) U.S. Cl. 358/1.15

(57) ABSTRACT

An image processing apparatus comprises a first image reading unit configured to read an image and generate image data; a storage unit configured to store the image data generated by the first image reading unit; a printing unit configured to print, on a sheet, an image describing information for identifying the image data stored in the storage unit; a second image reading unit configured to newly read an image and generate image data; an extraction unit configured to extract the information from the image data which is generated by reading the image one the sheet printed by the printing unit; and a combining unit configured to combine the image data stored in the storage unit and the image data generated by the second image reading unit, based on the information extracted by the extraction unit.

### BACKGROUND OF THE INVENTION

1. Field of the Invention

The present invention relates to an image processing apparatus, system, and image processing method for combining image data read by image readers.

2. Description of the Related Art

A user divides a large volume of originals into a plurality of bundles. A plurality of scanners connected to each other via a network scan the respective bundles. A server combines the scanned image data, obtaining a final digital document file. This technique is effective when reading a large volume of originals without occupying a device such as a scanner for a long time or when sequentially reading partially acquired originals to obtain one digital file finally.

According to this technique, a cover page describing information on the combination of a document in advance instructs the combination of read data (Japanese Patent Laid-Open No. 2000-224369). There is also proposed a method of designating the second scanner and automatically combining image data from respective scanners (Japanese Patent Laid-Open No. 2005-176191).

However, according to the former conventional technique, the user needs to create a cover page for each original bundle in advance. This technique cannot cope with a case in which, for example, the user did not intend to divide an original into a plurality of bundles at first. According to the latter conventional technique, the user needs to designate another scanner from a scanner that is to scan an original. This complicates the user operation.

### SUMMARY OF THE INVENTION

The present invention provides a technique capable of easily implementing processing of reading plural pieces of an original in a plurality of times and combining the read data.

In order to solve the aforementioned problems, the present invention provides an image processing apparatus comprising: a first image reading unit configured to read an image and generate image data; a storage unit configured to store the image data generated by the first image reading unit; a printing unit configured to print, on a sheet, an image describing information for identifying the image data stored in the storage unit; a second image reading unit configured to newly read an image and generate image data; an extraction unit configured to extract the information from the image data which generated by reading the image on the sheet printed by the printing unit; and a combining unit configured to combine the image data stored in the storage unit and the image data generated by the second image reading unit, based on the information extracted by the extraction unit.

The present invention also provides an image processing system comprising a plurality of image processing apparatuses, a first image processing apparatus including: a first image reading unit configured to read an image and generate image data; a storage unit configured to store the image data generated by the first image reading unit in a storage medium; and a printing unit configured to cause a printer to print, on a sheet, an image describing information for identifying the image data stored in the storage medium, and a second image processing apparatus including: a second image reading unit configured to read an image and generate image data; an extraction unit configured to extract the information form the image data which is generated by reading the image on the sheet printed by the printing unit; and a combining unit configured to combine the image data stored in the storage medium and the image data generated by the second image reading unit, based on the information extracted by the extraction unit.

The present invention also provides an image processing method of an image processing apparatus comprising: a first image reading step of causing an image reader to read an image and generate image data; a storage step of storing the image data generated in the first image reading step in a storage medium; a printing step of causing a printer to print, on a sheet, an image describing information for identifying the image data stored in the storage medium; a second image reading step of causing the image reader to read the image on the sheet and generate image data; an extraction step of extracting the information from the image data generated in the second image reading step; a third image reading step of causing the image reader to newly read an image and generate image data; and a combining step of combining the image data stored in the storage medium and the image data generated in the third image reading step, based on the information extracted in the extraction step.

According to the present invention, processing of reading plural pieces of an original in a plurality of times and combining the read data can be easily implemented.

Further features of the present invention will become apparent from the following description of exemplary embodiments (with reference to the attached drawings).

### BRIEF DESCRIPTION OF THE DRAWINGS

FIG. 1 is a view for explaining the configuration of an image processing system according to the first embodiment;

FIG. 2 is a block diagram for explaining the arrangement of a scanner 10 according to the first embodiment;

FIG. 3 is a block diagram for explaining the arrangement of a scanner 11 according to the first embodiment;

FIG. 4 is a flowchart for explaining the operation of the scanner 10 according to the first embodiment;

FIG. 5A is a view exemplifying the UI window of the scanner 10;

FIG. 5B is a view exemplifying a window for receiving a scan interrupt instruction;

FIG. 6 is a view exemplifying an interleave according to the first embodiment;

FIG. 7 is a flowchart showing scan processing of the scanner 11 according to the first embodiment;

FIG. 8 is a flowchart for explaining the operation of the scanner 10 according to the first embodiment;

FIG. 9 is a flowchart for explaining the operation of a scanner 11 according to the second embodiment;

FIG. 10 is a flowchart for explaining processing of a scanner 10 according to the second embodiment;

FIG. 11 is a view for explaining the configuration of an image processing system according to the third embodiment of the present invention;

FIG. 12 is a block diagram showing the hardware configuration of a document server according to the third embodiment;

FIG. 13 is a flowchart for explaining the operation of a scanner 10 according to the third embodiment;

FIG. 14 is a flowchart for explaining the operation of a scanner 11 according to the third embodiment; and

FIG. 15 is a flowchart for explaining the operation of the document server according to the third embodiment.

### DESCRIPTION OF THE EMBODIMENTS

Embodiments of the present invention will be described in detail below with reference to the accompanying drawings.

The following embodiments are merely examples for practicing the present invention. The embodiments should be properly modified or changed depending on various conditions and the structure of an apparatus to which the present invention is applied. The present invention should not be limited to the following embodiments.

### First Embodiment

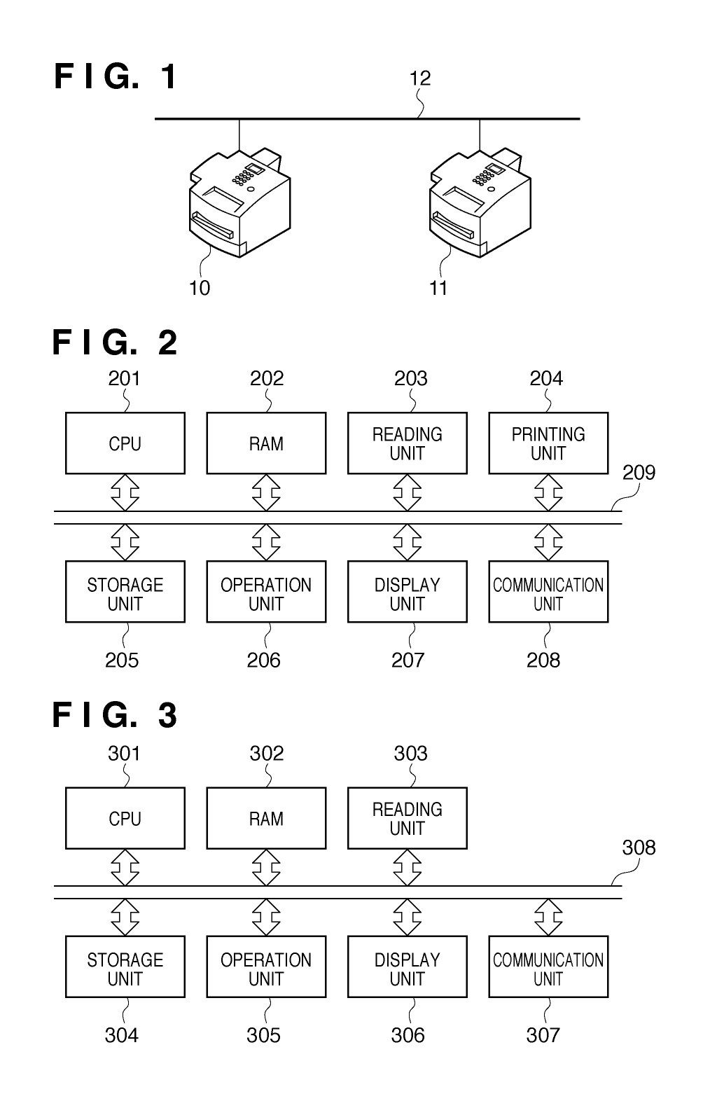

FIG. 1 is a view for explaining the configuration of an image processing system according to the first embodiment of the present invention.

In this system, a scanner 10 (first image processing apparatus) and a scanner 11 (second image processing apparatus) are connected to each other via a network 12. The following description assumes that the scanner 10 is integrated with a printer and the scanner 11 is a single scanner apparatus for reading an original. However, the present invention is not limited to this form.

FIG. 2 is a block diagram for explaining the hardware configuration of the scanner 10 according to the first embodiment.

A CPU 201 controls the overall operation of the scanner 10 in accordance with a program loaded from a storage unit 205 such as a hard disk into a RAM 202. The RAM 202 provides a work area in control processing by the CPU 201. A reading unit (first reading unit) 203 is an image reader that reads an image on an original or the like to generate corresponding image data. The reading unit 203 includes an automatic document feeding device (document feeder), and can sequentially feed plural pieces of an original set on the document feeder to read an image on the original. A printing unit 204 prints an image on a sheet based on image data. The storage unit 205 includes an NVRAM (or hard disk) for storing programs, various kinds of setting information, and the like according to the embodiment. The user (including an installation operator) uses an operation unit 206 to input a command. The operation unit 206 includes a keyboard, pointing device, touch panel, or the like. A display unit 207 displays a message, UI (User Interface) window, and the like to the user. A communication unit 208 communicates with another device (e.g., image processing apparatus) via the network 12. When the operation unit 206 includes the touch panel, the operation unit 206 and display unit 207 are integrated. A main bus 209 connects the CPU 201 to the respective units described above, and transmits control signals, data, and the like.

According to the first embodiment, in the scanner 10, the CPU 201 controls the RAM 202, reading unit 203, printing unit 204, storage unit 205, operation unit 206, display unit 207, and communication unit 208 via the main bus 209 to execute operations according to the first embodiment, unless otherwise specified.

FIG. 3 is a block diagram for explaining the hardware configuration of the scanner 11 according to the first embodiment.

A CPU 301 controls the overall operation of the scanner 11 in accordance with a program loaded from a storage unit 304 such as a hard disk into a RAM 302. The RAM 302 provides a work area in control processing by the CPU 301. A reading unit (second reading unit) 303 is an image reader that reads an image on an original or the like to generate corresponding image data. The reading unit 303 includes an automatic document feeding device (document feeder), and can sequentially feed plural pieces of an original set on the document feeder to read an image on the original. The storage unit 304 includes an NVRAM (e.g., hard disk) for storing programs, various kinds of setting information, and the like according to the embodiment. The user (including an installation operator) uses an operation unit 305 to input a command. The operation unit 305 includes a keyboard, pointing device, touch panel, or the like. A display unit 306 displays a message, UI (User Interface) window, and the like to the user. A communication unit 307 communicates with another device (e.g., image processing apparatus) via the network 12. When the operation unit 305 includes the touch panel, the operation unit 305 and display unit 306 are integrated. A main bus 308 connects the CPU 301 to the respective units mentioned above, and transmits control signals, data, and the like.

According to the first embodiment, in the scanner 11, the CPU 301 controls the RAM 302, reading unit 303, storage unit 304, operation unit 305, display unit 306, and communication unit 307 via the main bus 308 to execute operations according to the first embodiment, unless otherwise specified.

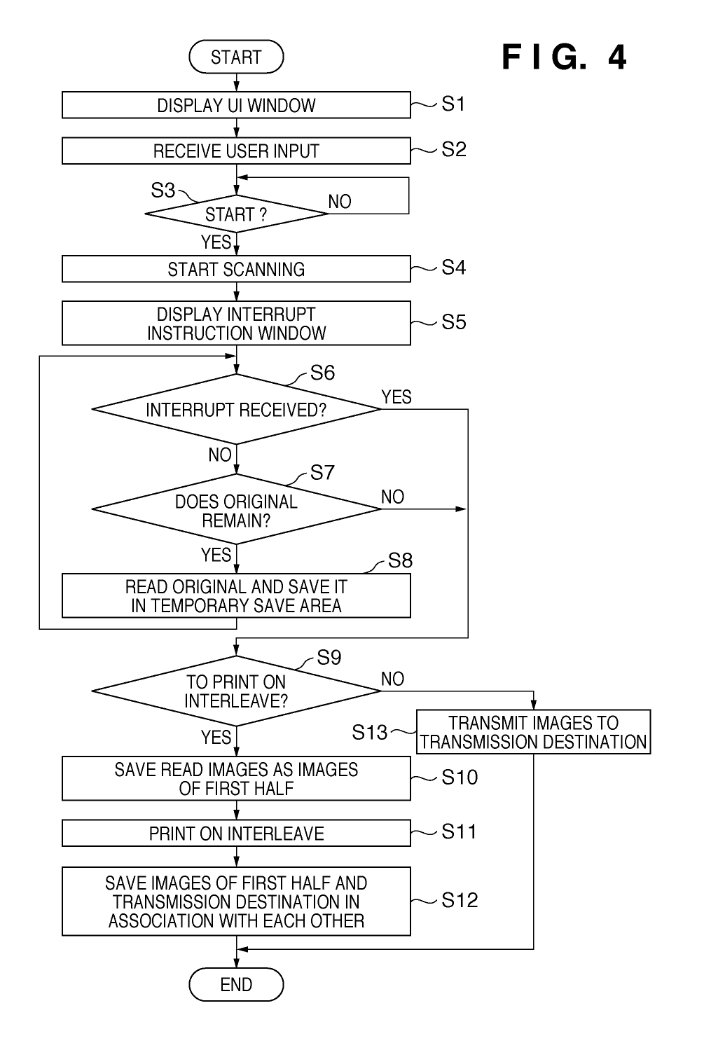

FIG. 4 is a flowchart for explaining an operation when the scanner 10 executes scanning according to the first embodiment. A program for executing this processing is loaded from the storage unit 205 to the RAM 202 in execution, and executed under the control of the CPU 201.

This processing starts when the scanner 10 is connected to the network 12 and starts the processing. In step S1, the scanner 10 displays a UI window on the display unit 207 to input settings regarding scanning and transmission.

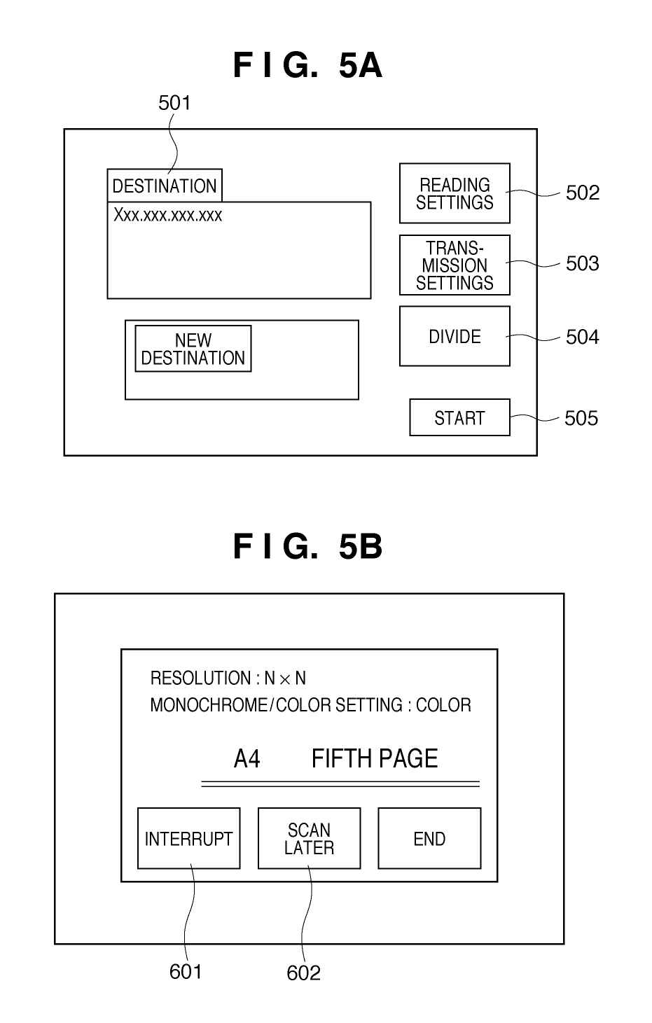

FIG. 5A is a view exemplifying the UI window of the scanner 10.

Examples of setting items here are a “destination” 501 to designate a transmission destination, “reading settings” 502 to designate reading conditions such as the reading resolution and color tone, and “transmission settings” 503 to designate the file format of image data to be transmitted. The setting items also include a button such as “divide” 504 which allows the user to, before reading an original, designate printing on an interleave. Note that the image data transmission destination also includes the storage unit 205 of the scanner 10. A “start” button 505 is used to designate the start of processing.

The process advances to step S2 to receive, from the operation unit 206, a user input to the UI window displayed in step S1. At this time, the storage unit 205 saves setting contents set by the user input.

In step S3, the scanner 10 determines whether the user has pressed the “start” button 505. If the user has pressed the “start” button, the process advances to step S4 to start reading (scanning) an original. The process then advances to step S5 to display a UI window on the display unit 207 to receive an interrupt instruction. This UI window is kept displayed on the display unit 207 till the end of scanning.

FIG. 5B is a view exemplifying a window for receiving a scan interrupt instruction.

Examples of the interrupt instruction are an “interrupt” 601 to designate a normal interrupt, and “scan later” 602 to designate an interrupt for printing on an interleave.

With the UI windows shown in FIGS. 5A and 5B, the image processing system can cope with a case in which before setting an original to start scanning it, the user decides to divide plural pieces of the original into a plurality of bundles, and a case in which, during scanning, he decides to divide an original into a plurality of bundles and scan them.

After that, the process advances to step S6 to determine whether the user has input an interrupt instruction via the operation unit 206 on the window of FIG. 5B. If the scanner 10 has received the interrupt instruction, the storage unit 205 saves which of a normal interrupt and an interrupt for printing on an interleave is designated by the interrupt instruction. The process then advances to step S9. If the scanner 10 has not received the interrupt instruction, the process advances to step S7 to determine whether the original still remains on the document feeder of the reading unit 203 or the user has input a reading end instruction to the operation unit 206. If no original remains on the document feeder or the user has input a reading end instruction, the process advances to step S9. If NO in step S7, the process advances to step S8, and the scanner 10 causes the reading unit 203 to read the original in accordance with the reading settings in the storage unit 205, and saves the read data in the storage unit 205. After that, the process returns to step S6.

If the scanner 10 determines in step S6 that it has received an interrupt instruction or determines in step S7 to end scanning, the process advances to step S9. In step S9, based on the settings which have been input by the user and saved in the storage unit 205, and the interrupt instruction, the scanner 10 determines whether to print on an interleave. If the scanner 10 determines not to print on an interleave, the process advances to step S13 to perform image processing according to the settings for image data which have been obtained by reading and stored in the storage unit 205. The scanner 10 reads out a determination destination and transmission settings from the storage unit 205, and transmits the image data to the transmission destination via the communication unit 208, after which the scan processing ends.

If the scanner 10 determines in step S9 to print on an interleave, the process advances to step S10 to save, as images of the first half in the storage unit 205, image data which have been obtained by reading and saved in the storage unit 205. The process advances to step S11 to print on an interleave using the printing unit 204.

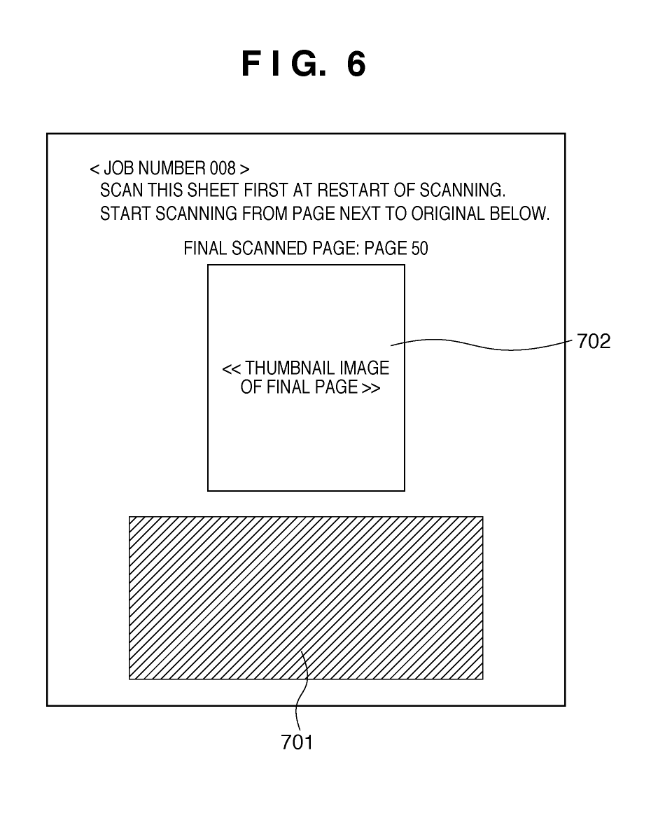

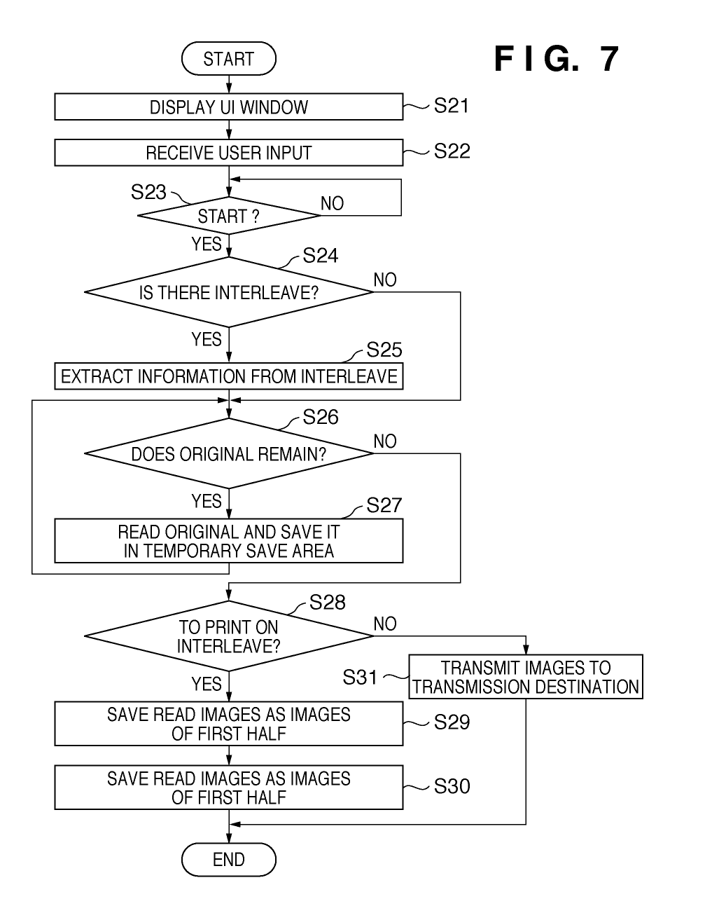

FIG. 6 is a view exemplifying an interleave printed in the first embodiment.

Embedded information 701 is printed on the interleave according to an embedding technique for a 2D barcode or the like. The embedded information 701 contains the identifier (e.g., IP address) of the apparatus (scanner 10 in this example) which saves images of the first half, and the identifier (e.g., UUID) of the images of the first half. To prevent a page count error when scanning the divided original bundle of the second half, the embedded information 701 may contain the information on the page count of the images of the first half and page information obtained by recognizing the character of a page number printed on the original. To save the effort of fine setting when scanning the original of the second half, information of reading settings in the storage unit 205 may be added to the embedded information 701. To more firmly prevent a user error of the page count of the original of the second half, the thumbnail of the final page among the images of the first half or the final page number among the images of the first half may be added as additional information 702. Upon completion of printing on an interleave, the process advances to step S12 to associate the images of the first half stored in the storage unit 205 with the transmission destination (storage location in the storage unit 205) and the transmission settings. After that, the processing ends. Note that the storage location of the images of the first half is not limited to a storage location set as a transmission destination, but may also be a temporarily storage location in the storage unit 205 or another storage medium.

FIG. 7 is a flowchart for explaining scan processing in the scanner 11 according to the first embodiment. A program for executing this processing is loaded from the storage unit 304 to the RAM 302 in execution, and executed under the control of the CPU 301.

This processing starts when the scanner 11 is connected to the network 12 and starts the processing. In step S21, the scanner 11 displays a UI window on the display unit 306 to input settings regarding scanning and transmission.

Examples of setting items here are a “destination” to designate a transmission destination, “reading settings” to designate the resolution, color tone, and the like, and “transmission settings” to designate a file format. In step S21, the user need not input the “destination” and “reading settings” depending on an interleave. The UI window example at this time is one obtained by excluding, for example, the “divide” button 504 from the example of FIG. 5A. In step S22, the scanner 11 receives a user input and transmission start instruction from the operation unit 305. At this time, if the user has made any settings, the storage unit 304 saves the content of these settings.

If the scanner 11 has received execution of scanning in step S23, the process advances to step S24 to determine whether an interleave is set in the reading unit 303. By using the interleave, the user can check the thumbnail of the final page among the images of the first half and a page count 302 that are printed on an interleave, avoiding an error of the page count of the original of the second half.

If the scanner 11 determines in step S24 that an interleave is set, the process advances to step S25; if NO, to step S26. In step S25, the scanner 11 causes the reading unit 303 to read the interleave. The scanner 11 extracts the embedded information 701 described on the interleave from image data generated by the reading unit 303, and saves it in the storage unit 304.

Thereafter, the process advances to step S26 to determine whether the original still remains on the document feeder of the reading unit 303 or the user has input a reading end instruction to the operation unit 305. If no original remains on the document feeder or the user has input a reading end instruction, the process advances to step S28. If NO in step S26, the process advances to step S27. In step S27, the scanner 11 causes the reading unit 303 to read the original in accordance with the reading settings in the storage unit 304, and saves the read data in the storage unit 304. The reading settings at this time may be those received in step S22 or those extracted from the embedded information 701 of the interleave in step S25. If the reading settings are extracted from the embedded information 701 of the interleave, no reading setting need be made in step S22, simplifying the user operation. Whether the page count of the original of the second half is correct may be determined from page information of the images of the first half extracted from the embedded information 701 upon reading an image in step S27. This can prevent an error of the page count of the original of the second half. This determination makes it possible to set even the original of the first half and skip scanning of only it when scanning the original of the second half. The character of a page number printed on the original of the second half may be recognized to discriminate the original of the first half which has already been read from the original of the second half to be read now.

The process then advances to step S28 to determine whether the information extracted from the interleave has been stored in the storage unit 304. If the scanner 11 determines that the extracted information has been stored, the process advances to step S29; if NO, to step S31. In step S31, the scanner 11 transmits the read image via a communication device 27 to the transmission destination stored in the storage unit 304 (normal scan processing). The processing then ends.

If the scanner 11 determines in step S28 that the extracted information has been stored, the process advances to step S29 to save, as images of the second half in the storage unit 304, the read images which have been saved in the storage unit 304 in step S27. Thereafter, the process advances to step S30 to transmit the images of the second half and the identifier of the images of the first half in the extracted information via the communication unit 307 to the apparatus (scanner 10 in this case) which has saved the images of the first half, for example, to the IP address of the scanner 10. Then, the processing ends. The scanner 10 receives image data of the original bundle of the second half divided by the interleave, and can combine them with image data of the original bundle of the first half that have been stored in the scanner 10.

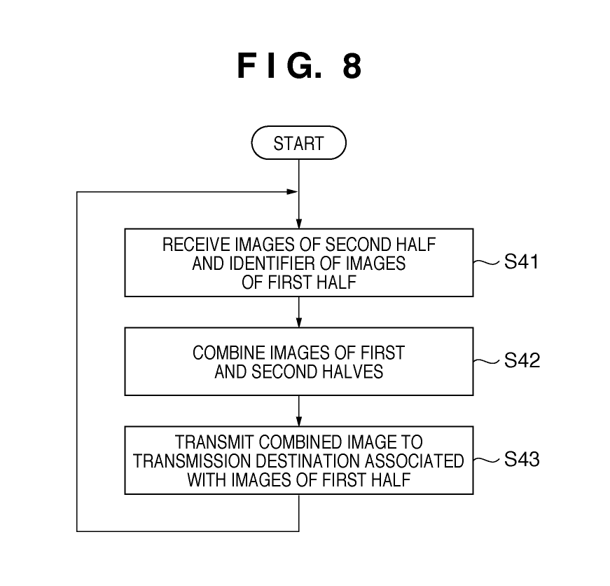

FIG. 8 is a flowchart for explaining an operation when combining images in the scanner 10 according to the first embodiment. A program for executing this processing is loaded from the storage unit 205 to the RAM 202 in execution, and executed under the control of the CPU 201.

In step S41, the scanner 10 receives, via the communication unit 208, the images of the second half and the identifier of the images of the first half that have been transmitted from the scanner 11. In step S42, the scanner 10 combines the images of the first half stored in the storage unit 205 with those of the second half received in step S41, and digitizes the combined image in accordance with the transmission settings stored together with the images of the first half. The process advances to step S43 to transmit the combined image via the communication unit 208 to the transmission destination set for the images of the first half. The processing then ends.

In this way, image data of an original of the first half read by the scanner 10 and those of an original of the second half read by the scanner 11 can be combined, obtaining an image file. The image file can be transmitted to a designated transmission destination.

In the first embodiment, the scanners 10 and 11 have different functions, but the scanner 11 may have the same functions as those of the scanner 10.

### Second Embodiment

The second embodiment of the present invention will be described. In the first embodiment, the scanner 10 combines images of the first and second halves. To the contrary, in the second embodiment, a scanner 11 that scans images of the second half combines images of the first and second halves, and transmits the combined image to a designated transmission destination in accordance with transmission settings made in advance.

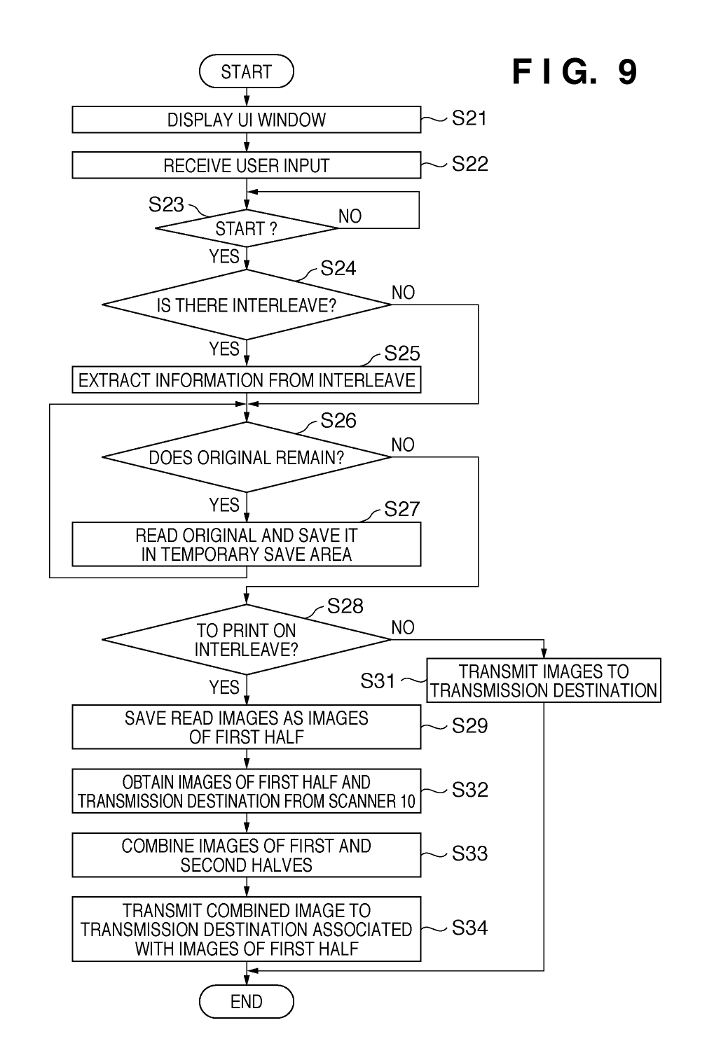

FIG. 9 is a flowchart for explaining an operation when the scanner 11 executes scanning according to the second embodiment of the present invention. A system configuration, and the arrangements of scanners 10 and 11 according to the second embodiment are the same as those in the first embodiment, and a description thereof will not be repeated.

In FIG. 9, processes in steps S21 to S29 and S31 are the same as those in FIG. 7 in the first embodiment, and a description thereof will not be repeated.

Upon completion of reading and saving images of the second half in step S29, the process advances to step S32 to obtain, from the scanner 10 via a communication unit 307, images of the first half, and transmission settings and a transmission destination associated with the images of the first half. These kinds of information can be obtained from the scanner 10 by specifying the IP address of the scanner 10 and the UUID of the images of the first half based on embedded information 701 which has been read from an interleave and stored in a storage unit 304. The process advances to step S33 to combine the images of the first half received in step S32 and the images of the second half stored in the storage unit 304 in step S27. The scanner 11 digitizes the combined image in accordance with the transmission settings stored in association with the images of the first half. Thereafter, the process advances to step S34 to transmit the combined image via the communication unit 307 to the transmission destination stored in association with the images of the first half. Then, the processing ends.

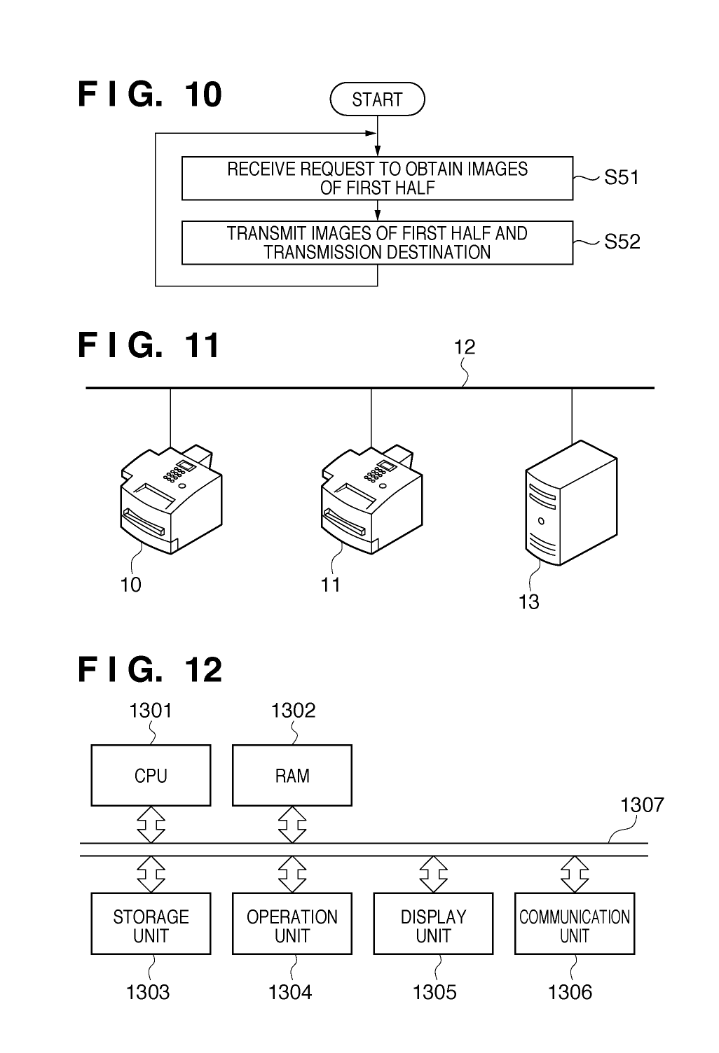

FIG. 10 is a flowchart for explaining processing in the scanner 10 according to the second embodiment. FIG. 10 shows processing when the scanner 11 obtains images of the first half from the scanner 10 in step S32 of FIG. 9.

In step S51, the scanner 10 receives a request from the scanner 11 via a communication unit 208 to obtain images of the first half saved in a storage unit 205. The process advances to step S52 to transmit the images of the first half stored in the storage unit 205, and transmission settings and a transmission destination associated with the images of the first half to the scanner 11 via the communication unit 208. After that, the processing ends.

According to the second embodiment, the scanner 11 can combine image data of an original of the first half read by the scanner 10 and those of an original of the second half read by the scanner 11, obtaining an image file. The image file can be transmitted to a designated transmission destination.

Also in the second embodiment, the scanner 11 may have the same functions as those of the scanner 10.

### Third Embodiment

The third embodiment of the present invention will be described. An image processing system according to the third embodiment further includes a document server 13. The document server 13 combines originals of the first and second halves and saves the combined original.

FIG. 11 is a view for explaining the configuration of an image processing system according to the third embodiment of the present invention.

Scanners 10 and 11 and the document server 13 are connected via a network 12. The scanners 10 and 11 are assumed to have the same arrangements as those of the scanners 10 and 11 in the first embodiment.

FIG. 12 is a block diagram showing the hardware configuration of the document server 13 according to the third embodiment.

A CPU 1301 controls the overall operation of the document server 13 in accordance with a program loaded from a storage unit 1303 such as a hard disk into a RAM 1302. The RAM 1302 provides a work area in control processing by the CPU 1301. The storage unit 1303 includes an NVRAM (e.g., hard disk) for storing programs, various kinds of setting information, and the like according to the embodiment. The user (including an installation operator) uses an operation unit 1304 to input a command. The operation unit 1304 includes a keyboard, pointing device, touch panel, or the like. A display unit 1305 displays a message, UI (User Interface) window, and the like to the user. A communication unit 1306 communicates with another device (e.g., image processing apparatus) via the network 12. When the operation unit 1304 includes the touch panel, the operation unit 1304 and display unit 1305 are integrated. A main bus 1307 connects the CPU 1301 to the respective units described above, and transmits control signals, data, and the like.

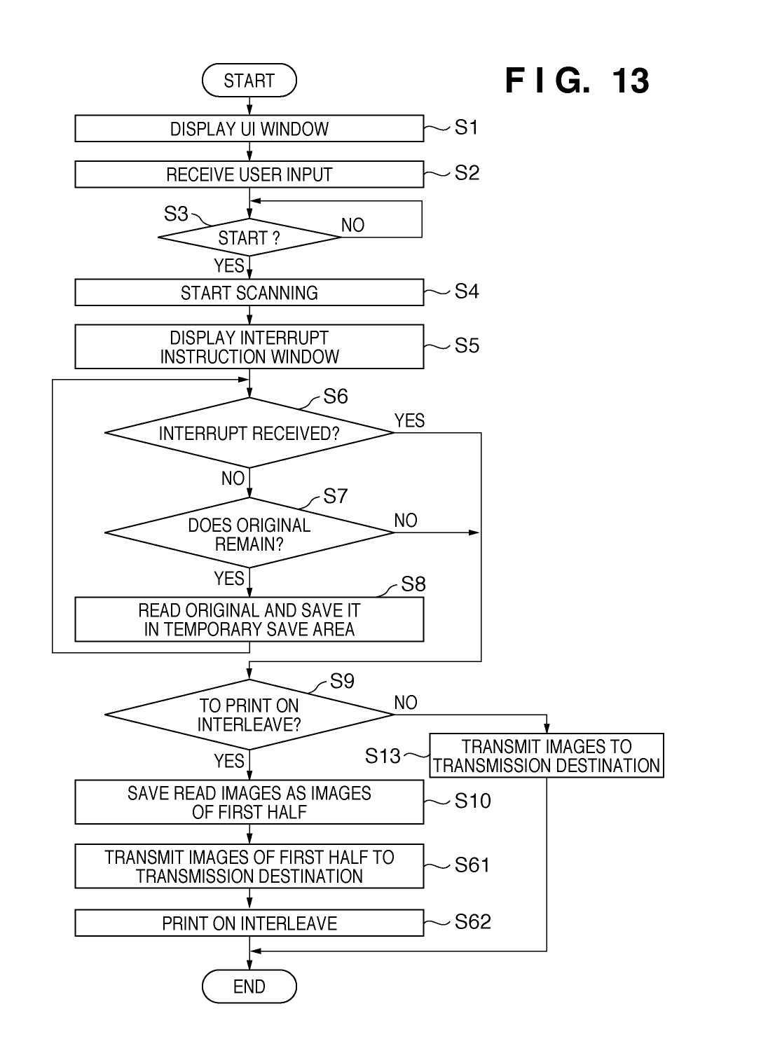

FIG. 13 is a flowchart for explaining an operation when the scanner 10 executes scanning according to the third embodiment. Operations in steps S1 to S10 and S13 are the same as those in steps S1 to S10 and S13 of FIG. 4 in the first embodiment. The same reference numerals denote the same steps, and a description thereof will not be repeated. A program for executing this processing is loaded from a storage unit 205 to a RAM 202 in execution, and executed under the control of a CPU 201.

In step S10, the scanner 10 stores image data which have been read as images of the first half in the storage unit 205. The process advances to step S61 to transmit the images of the first half stored in the storage unit 205, and their transmission settings to a transmission destination via a communication unit 208. At the same time, the scanner 10 obtains the identifier (e.g., UUID) of the images of the first half to be stored in the apparatus at the transmission destination. The process advances to step S62 to print on an interleave by a printing unit 204. Then, the processing ends. Note that the print processing for an interleave in step S62 is the same as print processing in step S11 of FIG. 4, and a description thereof will not be repeated.

In the third embodiment, the identifier of the storage location of the images of the first half is the identifier (e.g., the IP address of the document server 13) of a transmission destination.

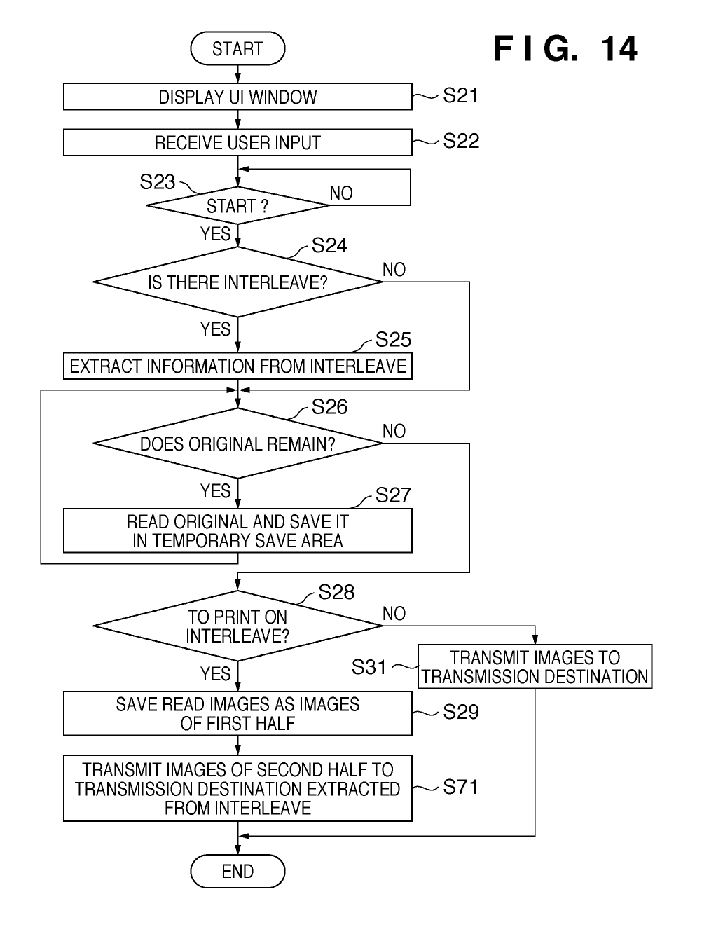

FIG. 14 is a flowchart for explaining an operation when a scanner 11 executes scanning according to the third embodiment. A program for executing this processing is loaded from a storage unit 304 to a RAM 302 in execution, and executed under the control of a CPU 301.

Operations in steps S21 to S29 and S31 are the same as those in FIG. 7 in the first embodiment. The same reference numerals denote the same steps, and a description thereof will not be repeated.

After saving image data which have been read as images of the second half in step S29, the scanner 11 transmits, in step S71 via a communication unit 307 to an apparatus which have saved images of the first half, the images of the second half and the identifier of the images of the first half that is contained in embedded information extracted from an interleave. Then, the processing ends. In this case, the scanner 11 transmits the images of the second half and the identifier of the images of the first half to the IP address of the document server 13.

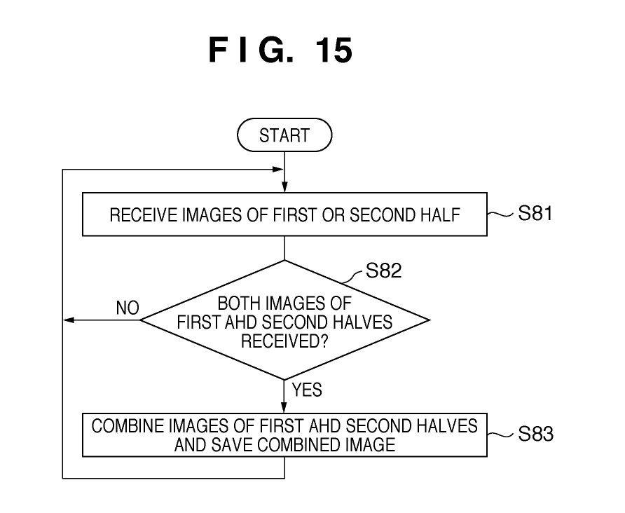

FIG. 15 is a flowchart for explaining an operation when combining images by the document server according to the third embodiment. A program for executing this processing is loaded from the storage unit 1303 to the RAM 1302 in execution, and executed under the control of the CPU 1301.

In step S81, the document server 13 receives, via the communication unit 1306, the images of the first half and the transmission settings from the scanner 10 or the images of the second half from the scanner 11, and saves them in the storage unit 1303. Upon completion of the reception, the process advances to step S82 to determine whether the storage unit 1303 have saved the images of the first half, the transmission settings, and the images of the second half. If the document server 13 determines in step S82 that all of them have been saved, the process advances to step S83; if it determines that not all of them have been saved, returns to step S81 again. In step S83, the document server 13 combines the images of the first and second halves in the RAM 1302. The document server 13 digitizes the combined image in accordance with the transmission settings associated with the images of the first half, and saves the digital image in the storage unit 1303.

Also in the third embodiment, the scanner 11 may have the same functions as those of the scanner 10.

As described above, according to the third embodiment, the document server 13 is connected to the network. The document server 13 can combine originals of the first and second halves and transmit the combined image to a designated transmission destination.

In the above description, a scanner for reading an original of the first half and a scanner for reading that of the second halve are different, but may be a single scanner. A printer arranged separately from a scanner may print on an interleave.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-058697, filed Mar. 11, 2009, which is hereby incorporated by reference herein in its entirety.

What is claimed is:

1. An image processing apparatus comprising:
a first image reading unit configured to read an image and generate image data;
a storage unit configured to store the image data generated by said first image reading unit;
a printing unit configured to print, on a sheet, an image describing information for identifying the image data stored in said storage unit;
a second image reading unit configured to newly read an image and generate image data;
an extraction unit configured to extract the information from the image data which is generated by reading the image on the sheet printed by said printing unit; and
a combining unit configured to combine the image data stored in said storage unit and the image data generated by said second image reading unit, based on the information extracted by said extraction unit.

2. The apparatus according to claim 1, wherein
the image printed by said print unit describes information for indicating a transmission destination of image data, and
the image processing apparatus further comprises a transmission unit configured to transmit the image data combined by said combining unit to the transmission destination indicated by the information extracted by said extraction unit.

3. The apparatus according to claim 1, wherein the image printed by said print unit describes information for indicating one of an address of the image processing apparatus, a final page number of the image data stored in said storage unit, and reading conditions of said first image reading unit and said second image reading unit.

4. An image processing system comprising a plurality of image processing apparatuses,
a first image processing apparatus including:
a first image reading unit configured to read an image and generate image data;
a storage unit configured to store the image data generated by said first image reading unit in a storage medium; and
a printing unit configured to cause a printer to print, on a sheet, an image describing information for identifying the image data stored in the storage medium, and
a second image processing apparatus including:
a second image reading unit configured to read an image and generate image data;
an extraction unit configured to extract the information from the image data which is generated by reading the image on the sheet printed by said printing unit; and
a combining unit configured to combine the image data stored in the storage medium and the image data generated by said second image reading unit, based on the information extracted by said extraction unit.

5. An image processing method of an image processing apparatus comprising:
a first image reading step of causing an image reader to read an image and generate image data;
a storage step of storing the image data generated in the first image reading step in a storage medium;
a printing step of causing a printer to print, on a sheet, an image describing information for identifying the image data stored in the storage medium;
a second image reading step of causing the image reader to read the image on the sheet and generate image data;
an extraction step of extracting the information from the image data generated in the second image reading step;
a third image reading step of causing the image reader to newly read an image and generate image data;
a combining step of combining the image data stored in the storage medium and the image data generated in the third image reading step, based on the information extracted in the extraction step.

6. The method according to claim 5, wherein
the image printed in said printing step describes information for identifying a transmission destination of image data, and
the image processing method further comprises a transmission step of transmitting the image data combined in the combining step to the transmission destination indicated by the information extracted in the extraction step.

7. The method according to claim 5, wherein the image printed in said printing step describes information for indicating one of an address of the image processing apparatus, a final page number of the image data stored in the storage medium, and a reading condition of the image reader.
